(19) United States
(12) Patent Application Publication
(10) Pub. No.: US 2023/0399256 A1
(43) Pub. Date: Dec. 14, 2023

(54) EMITTER COMPONENT WITH A REFLECTIVE LAYER, AND METHOD FOR PRODUCING SAME

(71) Applicant: Heraeus Noblelight GmbH, HANAU (DE)

(72) Inventor: Oliver WEIß, Kleinostheim (DE)

(21) Appl. No.: 18/250,307

(22) PCT Filed: Oct. 25, 2021
(86) PCT No.: PCT/EP2021/079502

§ 371 Date: Apr. 24, 2023

(30) Foreign Application Priority Data
Oct. 28, 2020 (DE) 10 2020 128 337.7

(51) Int. Cl. C03C 17/36; C03C 23/00; G02B 5/08

(52) U.S. Cl. CPC C03C 17/3649; C03C 17/3607; C03C 17/3663; C03C 23/007; G02B 5/085; C03C 2218/32

(57) ABSTRACT

In a known method for producing an emitter component with a reflector, a flowable aqueous SiO2 slip is produced using a slip method, and the slip is applied onto a quartz glass main part in the form of a slip layer. The slip layer is then dried and glazed, thereby forming a quartz glass layer which is more or less opaque and diffusely reflective. In order to produce an optical component with a reflective layer made of opaque quartz glass with increased reflective optical power, a method is proposed having the steps of: providing a main part with a surface which is at least partly coated with a reflective layer made of opaque glass, compressing a surface region of the reflective layer made of opaque glass, and applying a mirror-reflective layer on at least one part of the compressed surface region.

### TECHNICAL BACKGROUND

The invention relates to a method for producing an emitter component with a reflector.

Moreover, the invention involves an emitter component with a main part whose surface is at least partly coated with a reflector.

In lamp and reflector production, optical emitters are often provided with a reflector to minimize emission losses. The temporal constancy and the efficiency of the emitted optical power thereby play an important role.

### PRIOR ART

The surfaces of high-quality reflectors that may be used in a chemically aggressive environment, without the reflector material being damaged and the reflectance rapidly decreasing, often consist of gold. Such an emitter component, in the form of an infrared surface emitter equipped with a gold reflector, is known from DE 40 22 100 C1. The surface emitter is composed of a plurality of lamp tubes of quartz glass arranged side by side, which lamp tubes are mounted on a common carrier plate made of quartz glass. The upper side of this lamp tube arrangement forms the emission surface of the infrared surface emitter. The free underside of the quartz glass carrier plate arranged opposite thereto is provided with a reflector layer made of gold.

In DE 198 22 829 A1, a short-wave infrared emitter is described in which the lamp tube is executed in the form of what is known as a twin tube. A quartz glass cladding tube is hereby subdivided by a longitudinal web into two partial spaces running parallel to one another, wherein a heating spiral runs in one or both partial spaces. The side of the twin tube facing away from the main emission direction of the IR radiation is coated with a gold layer which serves as a reflector.

Reflector layers made of gold are characterized by high reflectivity; however, they are resistant to temperature and thermal shock only to a limited extent. Moreover, the reflection in the UV range decreases significantly.

A diffusely reflecting reflector layer made of at least partially opaque quartz glass, described in DE 10 2004 051 846 A1, which has also become known under the name “QRC” (Quartz Reflective Coating), avoids the disadvantages of the limited temperature stability and low reflectivity in the UV range. The production of the QRC reflector layer takes place by means of a slip method, in which a heavily loaded, pourable aqueous SiO₂ slip is produced which contains amorphous SiO₂ particles. This is applied as a slip layer onto the quartz glass main part, and then the slip layer is dried and glazed to form a more or less opaque quartz glass layer. Spraying, electrostatically assisted spraying, flooding, spinning, dipping, and painting are proposed for applying the slip layer onto the main part. A production of the reflector layer made of opaque quartz glass via thermal spraying is also described in DE 10 2006 062 166 A1.

DE 44 40 104 C2 discloses a mirror blank made of opaque quartz glass whose surface is thermally compressed, smooth, and non-porous. The compressed, transparent surface layer has a thickness of 3 mm, for example. A reflective coating for a mirror may be applied on the compressed surface layer after mechanical processing.

U.S. Pat. No. 3,445,662 A describes an infrared emitter with a gold reflector. The gold reflector consists of a metallic substrate, a diffusion barrier layer, and a gold layer. The diffusion barrier layer may consist of a dense SiO₂ layer 20 nm to 200 nm thick.

DE 10 2007 030 698 A1 describes a composite body which can be used as a thermal radiation reflector, which composite body is made up of a main part and a crack-free, dense sealing layer. The main part consists of porous opaque quartz glass; the sealing layer is produced via application and glazing of an SiO₂ mm slip and has a thickness of 0.8 mm.

DE 10 2013 104 466 A1 describes a UV lamp having a lamp tube which can be coated with a reflector layer made of opaque quartz glass. The layer thickness is between 0.2 and 2 mm.

### TECHNICAL OBJECT

The opaque quartz glass layer can be used as a diffuse reflector for radiation over a wide wavelength range. It is characterized by high temperature resistance, up to approximately 1000° C., and a high reflectivity in the wavelength range below 2.2 μm. In the longer wavelength range, its reflectivity for the primary radiation emitted by the radiation source is, however, markedly less than that of the gold reflector.

It is therefore an object of the invention to increase the reflected optical power in an optical component having a reflector layer made of opaque quartz glass.

Moreover, the invention is based on the object of specifying a method by means of which such an emitter component can be manufactured reliably and reproducibly.

### SUMMARY OF THE INVENTION

With regard to the manufacture of the emitter component, this object is achieved by a method comprising the following method steps:
(a) providing a main part with a surface that is at least partly coated with a reflector layer made of opaque glass,
(b) compressing a surface region of the reflector layer made of opaque glass,
(c) applying a mirror-reflective reflector layer on at least one part of the compressed surface region.

The main part coated with the reflector layer is, for example, an optical emitter or a component of an optical emitter, or is connected to the optical emitter. Or, the main part forms a separate reflector and is used in conjunction with an optical emitter, or it is a component of such a reflector.

The optical emitter emits primary radiation in a main propagation direction. At least a part of the surface of the main part which is situated opposite the main propagation direction of the primary radiation is designed as a reflector, and for this purpose is coated with a reflector layer made of opaque glass. This reflector layer is also referred to in the following, for short, as an “opaque layer”. A diffusely reflecting reflector layer made of opaque quartz glass is known under the name “ORO”, for example, and is commercially available. The opaque layer is characterized by an excellent chemical and thermal resistance and mechanical strength. Particularly noteworthy is the high thermal shock resistance of the opaque layer, especially if it consists of quartz glass or borosilicate glass.

In the method according to the invention, at least one part of the surface of the opaque layer is coated with a further reflector layer which is mirror reflective. This reflector layer is also referred to in the following, for short, as a “mirror layer”. Mirror reflection can, for example, be achieved by a metal layer which, given demanding applications, can be executed as a noble metal-containing layer, especially as a gold layer or gold-containing layer. The emitter component created according to the method according to the invention thus possesses a multi-layer reflector with an inner reflector layer made of opaque glass and an outer, mirror-reflective reflector layer made of metal, wherein the two reflector layers adjoin one another on a compressed glass region which is part of the opaque layer.

Typically, the opaque layer provided in method step (a) initially has an open-pore surface. A surface region of the opaque layer is compressed in advance before the mirror layer is applied thereon. The compression may take place by mechanical pressure or infiltration of a sealant, but preferably takes place thermally by heating of the main part, or preferably only of the surface region of the opaque layer to be compressed.

The compressed surface region preferably has only a few, ideally no, open pores. An open-pore surface is apparent in that it is absorbent, which can be detected using a dye penetration test or by means of mercury porosimetry. The absence of open pores is shown in that the closed-pore surface is not absorbent.

The production of the mirror layer normally takes place by applying a metal-containing emulsion (often this is a metal-containing resinate) which is subsequently fired by heating. The object of the compressed surface region is to avoid a penetration of layer components, or starting substances for their production, in the production of the mirror layer. For this purpose, a small layer thickness in the range of a few micrometers is sufficient. As a result of production, layer thicknesses of the compressed surface region of up to 500 μm are possible. However, thinner layers of less than 300 μm, and particularly preferably less than 150 μm, are preferred.

The thermally compressed surface region inasmuch forms a sealed “glass film”, and is also referred to as such in the following. If this is coated with a metal-containing emulsion and the emulsion is subsequently fired by heating, the result is a sealed, glossy reflector layer, for example a metallically shiny gold layer.

The component produced in such a way thus has a multi-layer reflector which is composed of an inner reflector layer made of opaque glass of a first porosity; a glass film in the form of a transition region made of glass having a second, lower porosity; and an outer, mirror-reflective reflector layer. The inner reflector layer made of opaque glass reflects diffusely if, for example, the opacity is definitively based on pores.

The outer mirror layer prevents the transmission of primary radiation through the inner opaque layer, and therefore produces an overall greater reflectance for the primary radiation than only the opaque layer alone. In comparison to an emitter component with only diffusely reflecting reflector layer, the emitter component with a multi-layer reflector therefore already exhibits a higher optical power density radiated in the main propagation direction.

Moreover, it has been shown that the opaque layer absorbs a portion of the primary radiation and thereby heats it. With increasing temperature as a result of absorption of the primary radiation, an undirected emission of secondary radiation from the opaque layer increases, the peak wavelength of which is, for example, at temperatures of more than 600° C. in the wavelength range, above 2.5 μm. In this wavelength range, the mirror layer has a high reflectivity and a low emissivity, and therefore itself emits less secondary radiation. It therefore directs the emission of the secondary radiation as a whole in the main propagation direction of the primary radiation, whereby emission and energy losses are additionally reduced.

Overall, the residual transparency of the opaque layer is eliminated and its secondary emission is reduced. The power radiated to the rear—counter to the main propagation direction of the primary radiation—is therefore reduced, whereas the power radiated forward—in the main propagation direction of the primary radiation—increases, so that radiation and energy losses are additionally reduced.

On the other hand, it has been shown that the mirror layer adheres well to the compressed surface region of the opaque layer. Without wishing to be bound to an explanation, this effect can be based on the fact that the opaque layer shields the mirror layer from heat due to its effect as a thermal insulator, or that its adhesion to the surface of the compressed (via sintering) surface region is better than on a glass surface produced by melting.

In any event, given a multi-layer reflector, both the opaque layer and the mirror layer appear to profit from the effect and presence of the respective other reflector layer, which is shown in an improved performance of the emitter component with respect to radiation efficiency and service life.

A method variant has proven particularly successful in which the compression of the surface region takes place by heating to a heating temperature of at least 1,100° C. during a heating period of at least 5 seconds.

The heating can occur in an oven, but preferably occurs via “fire polishing”. In fire polishing, the surface region is briefly heated locally to very high temperatures by means of laser, plasma, or burner flame. The opaque, porous base material is thereby converted into denser glass in a region close to the surface via sintering or glazing.

Upon further heating, the already compressed surface region acts as an effective heat insulator which prevents the underlying, still-opaque volume region from being exposed to increased temperature. On the one hand, this has the consequence that a volume region of the opaque reflector layer that is not or is less compressed remains below the compressed surface region, and that, on the other hand, only a thin, compressed surface layer is to be produced without especially drastic heating, but which is sufficient for the invention.

The two parameters of “heating temperature” and “heating duration” are mutually dependent. If the one parameter is small, the desired heating result can nevertheless be achieved if the other parameter is large. The desired heating result is a compressed surface region. The compressed surface region ideally no longer has an open porosity; it is completely sealed and not absorbent, which can be demonstrated by a dye penetration test or by means of mercury porosimetry.

The mirror layer is usually produced from a metal. For demanding applications of the component in a corrosive environment and at high temperatures, the mirror-reflective reflector layer is preferably produced from a gold-containing metal or from gold.

Depending on the requirement for the reflectance, the thickness of the mirror layer is preferably in a range of 50 nm to 300 nm. The thicker the layer, the greater the reflectance.

The thickness of the reflector layer made of opaque glass is preferably in the range of 0.5 mm to 2 mm, depending on the requirement.

Given a focus on a long service life of the emitter component, a formation of an optimally flat temperature gradient within the reflector layer, and an effective action of the opaque layer as a thermal insulator relative to the mirror layer, a comparatively large thickness is configured. A thickness is configured in the low range if the focus is on high reflectivity via an optimally effective contribution of the mirror layer.

It is thereby normally desirable that the initially opaque, diffusely reflecting reflector layer still maintains a certain volume even after the compression. Therefore, preferably upon compression according to method step (b), a surface region is formed that is less than 50%, preferably less than 20%, of the initial thickness of the reflector layer made of opaque glass (prior to the beginning of compression).

The method according to the invention is suitable not only for the factory adjustment of the reflectivity of the emitter component; rather, it can also be performed in a simple manner by retrofitting emitter components which are already in use. For a corresponding retrofitting, the provision of the main part according to method step (a) comprises a measure in which an emitter component that is in use, with a reflector layer made of opaque glass, is dismantled and is reworked using method steps (b) and (c).

With regard to the emitter component, the technical object specified above is achieved according to the invention in that it has a main part whose surface is at least partly coated with a reflector, which reflector comprises an inner reflector layer made of at least partially opaque glass and an outer, mirror-reflective reflector layer, wherein a sealed glass film is arranged between the inner reflector layer and the outer reflector layer.

The main part coated with the reflector layer is, for example, an optical emitter or a component of an optical emitter, or is connected to the optical emitter. Or, the main part forms a separate reflector and is used in conjunction with an optical emitter, or it is a component of such a reflector.

The optical emitter emits primary radiation in a main propagation direction. At least a part of the surface of the main part, which is situated opposite the main propagation direction of the primary radiation, is designed as a reflector and is coated with a reflector layer made of opaque glass (“opaque layer”).

The opaque layer is characterized by an excellent chemical and thermal resistance and mechanical strength. Particularly noteworthy is the high thermal shock resistance of the opaque layer, especially if it consists of quartz glass or borosilicate glass. Moreover, at least one part of the surface of the opaque layer is coated by a further reflector layer which is mirror reflective (“mirror layer”).

The emitter component according to the invention thus possesses a multi-layer reflector with an inner reflector layer made of opaque glass and an outer, mirror-reflective reflector layer, preferably made of metal, wherein the two reflector layers adjoin one another on a compressed glass region (“glass film”) which is part of the opaque layer.

The glass film is preferably dense and has only a few, ideally no, pores. It is the object of the glass film to avoid a penetration of layer components, or starting substances for their production, in the production of the mirror layer. For this purpose, a small layer thickness in the range of a few micrometers is sufficient, for example approximately 10 μm.

The emitter component according to the invention thus has a multi-layer reflector which is composed of an inner reflector layer made of opaque glass of a first porosity; a glass film in the form of a transition region made of glass having a second, lower porosity, and especially preferably without porosity; and an outer, mirror-reflective reflector layer.

The outer mirror layer prevents the transmission of primary radiation through the inner opaque layer, and therefore produces an overall greater reflectance for the primary radiation than only the opaque layer alone. In comparison to an emitter component with only diffusely reflecting reflector layer, the emitter component with a multi-layer reflector therefore exhibits a higher optical power density radiated in the main propagation direction.

The opaque layer absorbs a portion of the primary radiation and is thereby heated. With increasing temperature as a result of absorption of the primary radiation, an undirected emission of secondary radiation from the opaque layer increases, the peak wavelength of which is, for example, at temperatures of more than 600° C. in the wavelength range above 2.5 μm. In this wavelength range, the mirror layer has a high reflectivity and a low emissivity, and therefore itself emits less secondary radiation. It therefore directs the emission of the secondary radiation as a whole in the main propagation direction of the primary radiation, whereby emission and energy losses are additionally reduced.

Overall, the residual transparency of the opaque layer is eliminated and its secondary emission is reduced. The power radiated to the rear—counter to the main propagation direction of the primary radiation—is reduced, whereas the power radiated forward—in the main propagation direction of the primary radiation—increases, so that radiation and energy losses are additionally reduced.

The mirror layer shows good adhesion capability on the glass film. This effect can be based on the fact that the opaque layer shields the mirror layer from heat due to its effect as a thermal insulator, or that its adhesion to the surface of the compressed (via sintering) glass film is better than on a glass surface produced by melting.

In any event, given a multi-layer reflector, both the opaque layer and the mirror layer appear to profit from the effect and presence of the respective other reflector layer, which is shown in an improved performance of the emitter component with respect to radiation efficiency and service life.

The mirror layer usually consists of a metal. For demanding applications of the emitter component in a corrosive environment and at high temperatures, the mirror-reflective reflector layer preferably consists of a gold-containing metal or of gold.

Depending on the requirement for the reflectance, the thickness of the mirror layer is preferably in a range of 50 nm to 300 nm. The thicker the layer, the greater the reflectance.

The thickness of the reflector layer made of opaque glass is preferably in the range of 0.5 mm to 2 mm, depending on the requirement.

Given a focus on a long service life of the emitter component, a formation of an optimally flat temperature gradient within the reflector layer, and an effective effect of the opaque layer as a thermal insulator relative to the mirror layer, a comparatively large thickness is preferred. Given a thickness in the low range, the focus is placed more on high reflectivity via an optimally effective contribution of the mirror layer.

In particularly preferred embodiments of the emitter component, the main part is designed as an enveloping body for receiving a radiation emitter, wherein the reflector is arranged on the outer side of the enveloping body, facing away from the radiation emitter, or the main part is designed as a tile-shaped radiation emitter, wherein the reflector is arranged on a plane side of the tile.

In the first cited embodiment, the enveloping body for receiving a radiation emitter has the shape of a piston, or it is tubular, and has an arbitrary cross section, in particular a round or oval cross section. A plurality of tubular enveloping bodies may be aligned with their longitudinal axes parallel to one another and, for example, form a flat emitter. The reflector is hereby arranged on the outer side of the enveloping body, facing away from the radiation emitter.

The enveloping body hereby surrounds a radiation emitter, such as a heating spiral, a carbon band, or a radiation-emitting gas charge, and at the same time a part of the enveloping body is provided with a layer made of the opaque glass acting as a reflector.

In the second cited embodiment, the main part is designed as a tile-shaped radiation emitter, wherein the reflector made of opaque glass is arranged on one of the planar tile sides that is situated opposite the main propagation direction of the primary radiation.

The emitter component is preferably used in lamp and reflector manufacturing, wherein it is present in the form of a tube, piston, chamber, half-shell, spherical or ellipsoidal segment, plate, heat shield, or the like.

### Definitions

Emitter Component

The emitter component comprises a main part whose surface is at least partly coated with a reflector layer made of opaque glass. The main part is, for example, an optical emitter or a reflector component.

Reflector Layer Made of Opaque Glass

The reflector layer completely or partially covers the main part. It preferably consists of at least partially opaque quartz glass. It can produce diffuse, undirected reflection at phase boundaries. A directed portion can be impressed on the diffuse reflection by a curved or convex geometry of the main part.

### EXEMPLARY EMBODIMENT

The invention is explained in more detail below using exemplary embodiments and a drawing. Thereby shown in detail are

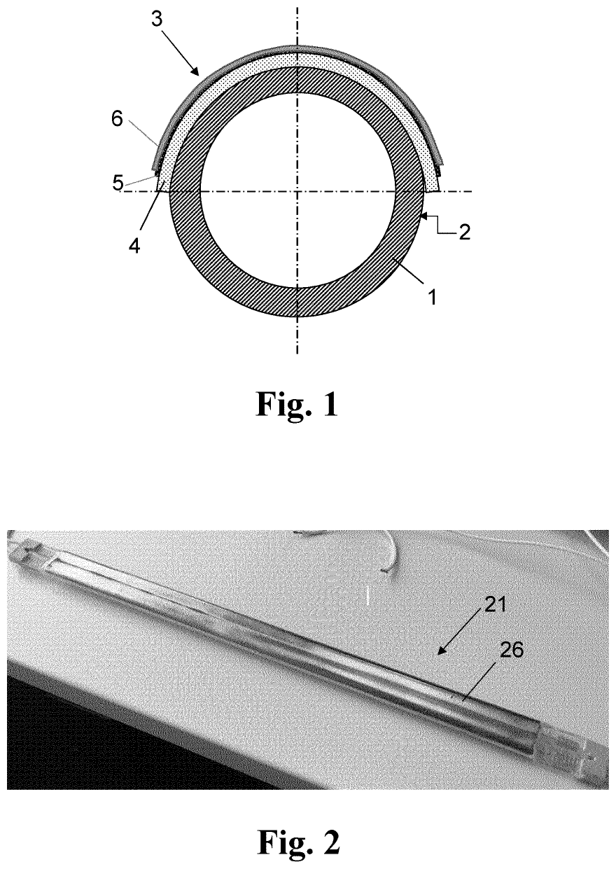

FIG. 1 in schematic presentation and in cross section, an embodiment of an emitter component according to the invention in the form of an infrared emitter with a cladding tube, the upper side of which is partially covered with a reflector layer,

FIG. 2 a photo of a short-wave twin tube infrared emitter with a QRC reflector layer, which has subsequently been coated with a gold reflector (after the infrared emitter has been put into operation) using the method according to the invention, and

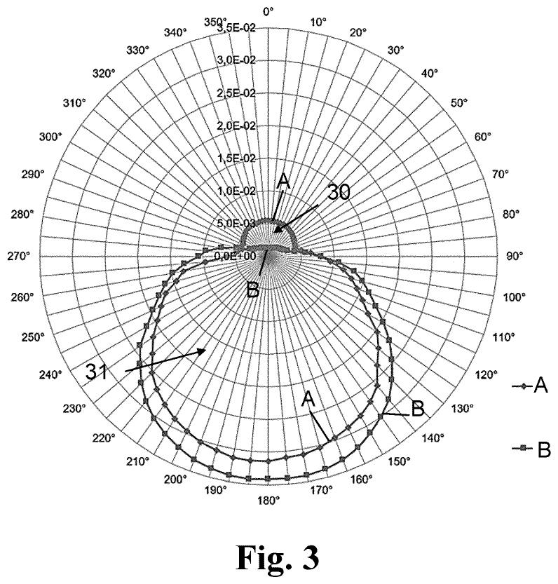

FIG. 3 a diagram with the result of radial measurements of the emission of infrared emitters with and without a mirror-reflective reflector layer, in comparison.

FIG. 1 schematically shows a horizontal lamp tube 1 made of quartz glass in cross section, the outer lateral surface 2 of which is coated approximately on one half of a side with a reflector 3. The reflector 3 is composed of an inner, diffusely reflecting reflector layer (opaque layer 4), an intermediate layer in the form of a thermally compressed surface region of the opaque layer 4 (glass film 5), and an outer mirror-reflective reflector layer (mirror layer 6). The presentation is not to scale; in particular, the thicknesses of glass film 5 and mirror layer 6 are shown extremely thick to improve recognizability.

A preferred procedure for producing the reflector 3 is explained in more detail in the following:

The production of the opaque layer 4 on the outer shell surface 2 of the cladding tube 1 takes place according to the known slip method described in DE 10 2004 051 846 A1. The flowable aqueous SiO₂ slip is applied as a slip layer on the upper side of the cladding tube 1; the slip layer is subsequently dried and glazed to form the opaque layer 4. The opaque layer 4 thus obtained consists of porous, opaque quartz glass. It has a mean layer thickness of 2 mm and a density of approximately 2.15 g/cm 3. Its surface is open-pored, as shown by a dye penetration test.

### COMPARATIVE EXAMPLE

In first experiments, the open-pore surface was impregnated with a gold-containing emulsion (gold resinate). The emulsion thereby penetrated into the open pores of the surface and was subsequently fired via heating. Upon firing, the gold resinate decomposes into metallic gold and resin acid which, for their part, along with the other components of the paste, are volatilized by the high firing temperature. However, contrary to expectation, a sealed, reflective metal layer, for example a noble metal layer, did not result; rather, the mass discolored black upon firing.

### Example

In further experiments, the surface of the opaque layer 4 was thermally compressed beforehand before the mirror layer 6 is applied thereon. The thermal compression takes place by heating the opaque layer 4 with an oxyhydrogen burner. Very high temperatures of around 1800° C. are thereby produced locally, which enables the production of an optimally thin compression region (glass film 5) within a few seconds. The glass film 5 has only the function of sealing the surface of the opaque layer 4, and is kept as thin as possible and only as thick as necessary to fulfill this function. The thickness is approximately 200 μm, but at most 500 μm. Its surface is then dense and has no open porosity, as a dye penetration test shows. To reduce mechanical stresses, the cladding tube 1 is subsequently tempered in an oven. The tempering program includes heating to a temperature of around 1050° C. for a period of at least 3 hours.

The mirror layer 6 is subsequently applied onto the glass film 5 in the usual manner by printing, spraying, dipping, or coating technology. In the exemplary embodiment, an approximately 5 μm thick layer of a paste is applied onto the glass film 5 with a brush, which layer consists of a solution of gold resinate in a thick oil with low additives (˜1%) of resinates of glass formers for adhesion promotion. The cladding tube 1 with the deposited resinate layer is brought to a temperature of around 800° C. in an oven. In this heat treatment, the gold resinate decomposes into metallic gold and resin acid which, for their part, along with the other components of the paste, are volatilized by the high firing temperature. A thin, metallic mirror layer 6 of approximately 0.1 μm remains on the glass film. The mirror layer 6 thus produced (gold layer) exhibits no defects and a good adhesion to the thermally compressed glass layer 5.

The subsequent gold plating of an emitter that is already in use with a mirror layer 26 is explained using FIG. 2. The photo shows a short-wave infrared emitter in the form of what is known as a “twin tube emitter” 21, the upper side of which was provided with a reflector, in the form of an opaque layer with an open-pore surface, upon being put into operation. To produce the mirror layer 26, the twin tube emitter was dismantled and the surface of the opaque layer was subsequently thermally compressed, as explained above, and finally provided with a gold layer. The gold layer shows no defects and a good adhesion to the thermally compressed opaque layer.

In order to determine the effect of the additional mirror layer, the emitted optical power density (irradiance) was measured at infrared emitters with and without mirror layer. The radial measurement takes place in the usual manner using an infrared emitter mounted on a rotatable mounting, which rotates by 360 degrees in 5 degree increments. A thermopile sensor mounted at a distance of 20 cm thereby detects the radiation emitted by the infrared emitter. In the diagram of FIG. 3, the normalized irradiance (rel. unit) on the circle radius is plotted against the circumferential angle position (in degrees) of the measuring points. The measurement curve A, marked with diamonds, shows the result of the radial measurement given a commercially available short-wave infrared emitter with a diffusely reflecting reflector layer (“QRC emitter”), and the measurement curve B, marked with rectangles, shows the result of the radial measurement given retrofit coating of the QRC emitter with a gold layer using the method according to the invention.

In the rear emitter chamber 30, the measurement curve A shows a certain proportion of irradiation intensity. This is composed of transmitted primary radiation and of secondary radiation, which is to be ascribed to the heating of the opaque layer and the secondary radiation of the QRC emitter that is therefore diffusely emitted. In the measurement curve B, this portion is not present, or is at least markedly smaller than in measurement curve A.

In contrast, in the actual irradiation field 31, the measurement curve B shows a higher irradiance than the measurement curve A. This is to be ascribed to the fact that the secondary radiation radiated backwards is reduced by the gold reflector and instead is directed forward, and the power radiated forward is increased accordingly.

Via the additional gold reflector, the effective reflectivity of the infrared emitter increases from 82% (measurement curve A) to 91% (measurement curve B), and the power that can be used for the heating process increases by approximately 11%. These values result via integration of the areas enclosed by the measurement curves A or B in the rear space 30 or in the irradiation field 31.

1. A method for producing an emitter component with a reflector, including the method steps:
(a) providing a main part with a surface that is at least partly coated with a reflector layer made of opaque glass,
(b) compressing a surface region of the reflector layer made of opaque glass,
(c) applying a mirror-reflective reflector layer on at least one part of the compressed surface region.

2. The method according to claim 1, wherein the compressing of the surface region takes place by heating to a heating temperature of at least 1,100° C. during a heating period of at least 5 seconds.

3. The method according to claim 1, wherein that the mirror-reflective reflecting reflector layer is produced from a metal.

4. Method according to claim 3, wherein the mirror-reflective reflector layer is produced from a gold-containing metal or from gold, and has a layer thickness in the range of 50 to 300 nm.

5. The method according to claim 1, wherein the reflector layer is made of opaque glass having a thickness in the range of 0.5 mm to 2 mm.

6. The method according to claim 5, wherein, upon compression according to method step (b), a surface region is formed which has less than 50% of the thickness of the reflector layer made of opaque glass.

7. The method according to claim 1, wherein the provision of the main part according to method step (a) includes a measure in which an emitter component that is in use, with a reflector layer made of opaque glass, is dismantled and is reworked using the method steps (b) and (c).

8. An emitter component having a main part whose surface is at least partly coated with a reflector, which reflector comprises an inner reflector layer made of at least partially opaque glass and an outer, mirror-reflective reflector layer, wherein a sealed glass film is arranged between the inner reflector layer and the outer reflector layer.

9. The emitter component according to claim 8, wherein the glass film has a thickness of less than 300 μm, preferably less than 150 μm.

10. The emitter component according to claim 8, wherein the mirror-reflective reflector layer consists of a metal, preferably of a gold-containing metal or of gold; and in that it has a layer thickness in the range of 50 to 300 nm.

11. The emitter component according to claim 8, wherein the reflector layer made from opaque glass is provided with a thickness in the range of 0.5 mm to 2 mm.

12. The emitter component according to claim 8, wherein the main part is designed as an enveloping body for receiving a radiation emitter, wherein the reflector is arranged on the outer side of the enveloping body, facing away from the radiation emitter; or in that the main part is designed as a tile-shaped radiation emitter, wherein the reflector is arranged on a plane side of the tile.
